(19) United States
(12) Patent Application Publication
(10) Pub. No.: US 2026/0284566 A1
(43) Pub. Date: Sep. 24, 2026

(54) ACETYLENE PROCESS GAS PURIFICATION METHODS AND SYSTEM

(71) Applicant: Nippon Sanso Matheson, Inc., Irving, TX (US)

(72) Inventors: Joseph Vininski, Erie, CO (US); Kieran Lynn, Millburn, NJ (US); Will Copeland, Camano Island, WA (US); Robert Torres, JR., Parker, CO (US)

(73) Assignee: Nippon Sanso Matheson, Inc., Irving, TX (US)

(21) Appl. No.: 19/557,369

(22) Filed: Mar. 5, 2026

Related U.S. Application Data
(60) Provisional application No. 63/774,009, filed on Mar. 18, 2025.

(51) Int. Cl. B01D 53/00; B01D 53/22; B01D 53/26; B01D 53/78; B01D 63/02; B01D 63/10

(52) U.S. Cl. CPC B01D 53/002; B01D 53/228; B01D 53/229; B01D 53/26; B01D 53/78; B01D 63/02; B01D 63/10; B01D 2256/24; B01D 2257/406; B01D 2257/702

(57) ABSTRACT

The present invention relates to methods and systems of purifying an acetylene process gas. The methods may include the steps of providing an acetylene vessel containing source acetylene mixed with a solvent impurity and flowing the source acetylene through a purification container that holds a cooled purifying medium, where at least a portion of the solvent impurity in the source acetylene separates as a liquid impurity on the purifying medium. The method may also include removing the liquid from the purification container and flowing a purified acetylene gas from the purification container. The purified acetylene gas has a concentration of the solvent impurity of about 5 vol. % or less, and the separated liquid impurity is removed without interrupting the flow of the acetylene while the purified acetylene gas flows from the purification container to keep the concentration of the solvent impurity substantially constant in the purified acetylene gas.

### CROSS REFERENCE TO OTHER APPLICATIONS

This application claims the benefit of U.S. Provisional Application No. 63/774,009, filed Mar. 18, 2025, the entire contents of which are incorporated herein by reference.

### BACKGROUND OF THE INVENTION

Fluid purification systems and methods are described for producing purified process gases for applications such as the semiconductor fabrication processes. The systems and methods include cooling an unpurified starting gas to separate impurities into liquid phase onto a purifying medium and leaving a purified gas for the application. Techniques and purifier components provide for the disposal of the condensed impurities without interrupting the flow of the purified gas to the application.

In many applications for purified process gases there is an increased need for higher levels of purity. This need is acutely felt in the semiconductor fabrication industry, where increasing control and precision in the processing environment require electronic gases that are exceedingly pure. However, the demand for higher purity gases has to be balanced with the cost and reliability of the systems used to supply those gases.

For example, the semiconductor industry needs increasingly pure sources of acetylene gas to fabricate carbon containing components such as dielectric films and photolithographic masks. Acetylene is filled in cylinders containing a porous substance saturated with solvent, such as acetone or dimethylformamide (DMF). The solvent in conjunction with the porous substance increases the capacity of the storage cylinders and helps stabilize the gas under pressure by dissolving acetylene gas thus preventing it from decomposing explosively. However, when the acetylene is discharged from the cylinders, vapors of the solvent also accompany the acetylene gas. The solvent vapors are the largest component of impurities, among other impurities in acetylene gas. Moreover, as the acetylene is being removed from the storage cylinder its concentration in the cylinder drops relative to the concentration of the solvent. This results in an increasing concentration of the solvent impurities in the starting acetylene over the lifetime of the cylinder. The solvent impurity along with its increasing concentration over time in the acetylene gas leads to upsets in certain semiconductor fabrication processes that use acetylene gas. Since the semiconductor fabrication processes are very sensitive to the changing concentration of solvent impurity in the acetylene gas, the cylinder usage is limited to the region where solvent concentration is low and relatively constant compared to the increasing solvent concentration that is observed as the cylinder is consumed and approaches the end of the cylinder service, which results in frequent cylinder change outs and waste of gas. The solvent concentration level can be different from cylinder to cylinder which can cause the user to make process adjustments upon every cylinder exchange, ultimately time away from production process time.

In certain cases, the acetylene gas stored in cylinders could be passed through an on-site filter to remove solvent impurities before being used in an application. The filters are placed downstream of the storage cylinder and designed to remove the solvents so that only purified acetylene gas reaches the fabrication application. Delivering purified acetylene with consistently low solvent impurities is challenging because the amount of the impurities that need to be removed is significant, and changes over time. Thus, the purifier has to accommodate changing impurity levels in the starting acetylene to produce a purified gas with a constant low level of the impurities.

Because the solvent impurities are intentionally added to the acetylene, they are present in relatively large quantities in the source gas, which places significant stress on the purifier to keep the impurity concentrations low in the purified product. It is typical for the purifier material to saturate or be consumed before an application run has been completed, forcing the run to shut down prematurely to regenerate or replace the purifier. These shutdowns cause a significant decrease in the productivity of the fabrication process. As the thresholds for acceptable impurity levels keep going lower, the shutdowns become more frequent.

Thus, there is a need for new methods and systems to produce highly pure process gases with constant low levels of solvent impurities, decreasing frequency of cylinder change-outs, and increasing usage of the stored gases. These and other problems are presently addressed.

### BRIEF SUMMARY OF THE INVENTION

Acetylene purification methods and systems are described that permit accumulating liquid impurities to be removed (e.g., drained) from a purification unit without interrupting the flow of purified acetylene. This reduces the amount of down time for processes that consume the purified acetylene, such as electronic semiconductor fabrication processes.

The methods and systems may also be responsive to the rate at which the impurities separate from the source acetylene and adjust the impurity removal rate to keep the impurity concentration at a constant low level in the purified acetylene gas. This can be beneficial when purifying acetylene from a storage cylinder where the acetylene is stored under pressure with a solvent that provides the bulk of the liquid impurities. A full storage cylinder has a higher ratio of acetylene to solvent impurity than a cylinder approaching empty, and this is reflected in an increasing concentration of the impurity in the acetylene flow as the cylinder is emptied. The methods and systems can respond to the increasing impurity concentration in the source acetylene by removing the separated liquid impurities at an increased rate.

The liquid impurities may be removed by passing them through an outlet in a purification container (or downstream of the container) that is intermittently or continuously open while acetylene flows through the container. Gravity or a pressure gradient, or both pull the liquid impurities through the outlet to keep the purification container from becoming oversaturated with the liquid. Because the liquids are removed during purification operations, there is no need to periodically stop the acetylene flow to drain the liquid contaminants from the purification container.

Embodiments of the invention include methods of purifying an acetylene process gas by removing methane and other light hydrocarbons from acetylene. The methods may include the steps of providing an acetylene source vessel containing acetylene mixed with a solvent impurity and other light hydrocarbons, such as but not limited to methane, and flowing the source acetylene through a scrubber followed by a purification container that holds a cooled purifying medium and a filter membrane, such as but not limited to a coalescing filter, or a polymeric or ceramic membrane, where at least a portion of the solvent impurity in the source acetylene separates out as a liquid impurity on the purifying medium. The acetylene will permeate through the membrane and methane will be left behind on the residue/retentate side of the membrane. The efficiency of the acetylene purification and acetylene recovery will depend on the acetylene/methane separation factor for the membrane material, partial pressure difference of acetylene (driving force) across the membrane, and effective surface area of the membrane. Acetylene is a more condensable and interactive molecule than methane and, therefore, has higher solubility and permeability through non-porous polymer materials. There will be some acetylene in the retentate stream which will be important in calculating recovery of acetylene. The membrane material for this separation could be a thin non-porous polymer membrane supported on a porous matrix. The membrane module configurations could be either spiral wound or hollow fiber. The methods may also include removing the liquid impurities from the purification container and flowing a purified acetylene gas from the purification container. The purified acetylene gas can have a concentration of the solvent impurity of about 5 vol. % or less, and the separated liquid impurity may be removed while the purified acetylene gas flows from the purification container to keep the concentration of the solvent impurity substantially constant in the purified acetylene gas.

Embodiments of the invention further include additional methods of purifying an acetylene process gas. The methods may include the steps of providing an acetylene source vessel containing acetylene mixed with more than one solvent impurity and flowing the source acetylene through a purification container cooled to a temperature below room temperature (e.g., from about 0° C to about –200° C), whereupon the solvent, such as acetone will condense and can then be removed as a liquid. These low temperatures can also freeze the liquid impurities as well as moisture in and around the system while the purified acetylene gas flows from the purification container to keep the concentration of the solvent impurity substantially constant in the purified acetylene gas. Thus, the present invention further prevents or minimizes ice formation through the use of vacuum jacketed pipes, and a heat sink device in area of the waste drain or a combination of both.

Embodiments of the invention also include methods of purifying an acetylene process gas. The methods may include the steps of providing an acetylene source vessel containing acetylene mixed with more than one solvent impurity and flowing the source acetylene through a purification container cooled to a temperature below room temperature. In the present purification system, an upstream sensor is placed before the purification container to measure the initial acetone concentration, a second downstream sensor verifies whether the removal process is effective, and a third sensor analyzes the purified acetylene and aids in determining whether to flow the purified gas to the application or back through the purification container. The purified acetylene gas can have a concentration of the solvent impurity of about 5 volume percent or less, and the separated liquid impurity may be removed while the purified acetylene gas flows from the purification container to keep the concentration of the solvent impurity substantially constant in the purified acetylene gas.

Embodiments of the invention may also include systems for purifying an acetylene process gas. The systems may include an acetylene vessel containing source acetylene mixed with a solvent impurity, and a purification container fluidly coupled to the acetylene vessel. The purification container may contain a purifier medium upon which at least a portion of the solvent impurity in the source acetylene separates out as a liquid impurity. The systems may also include a temperature control system thermally coupled to the purification container, where the temperature control system lowers the temperature of the purifier medium to promote the separation of the solvent impurity as a liquid on the purifier medium. A flow control device may be formed on the purification container or downstream of the container to allow the passage of the separated liquid impurity out of the purification container while the source acetylene flows into the purification container. The flow control device may include an orifice, a needle valve, a mass flow controller, a check valve, a regulator, or a ball valve. The flow control device may be coupled to a vent channel outside the purification container that facilitates the liquid impurity flowing out of the purification container. The system may still further include an outlet formed in the purification container through which the purified acetylene gas passes. The system may further include purifier elements both upstream and downstream from the purification container to separate out both organic and chemical impurities. The upstream purifier may be a gas scrubber filled with dilute sulfuric acid (in the range of 5–10%) or dilute HCl (in the range of 5–10%) which can be used to neutralize alkaline impurities such as ammonia (NH₃), while the downstream purifier can be used to dry the purified acetylene. The purified acetylene gas may have a concentration of the solvent impurity of about 5 vol. % or less, and the separated liquid impurity may be removed while the purified acetylene gas flows from the purification container to keep the concentration of the solvent impurity substantially constant in the purified acetylene gas.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a simplified schematic drawing of an acetylene gas purifier according to embodiments of the invention;

FIG. 2 is a schematic drawing of an acetylene gas purifier according to embodiments of the invention;

FIG. 3A is a three-dimensional drawing of an acetylene gas purifier according to embodiments of the invention;

FIG. 3B is a magnified cross-sectional view of the cooling container wall taken along line 3B—3B of FIG. 3A showing an insulative vacuum space.

FIG. 3C is a magnified cross-sectional view of the cooling container wall taken along line 3C—3C of FIG. 3A showing a vacuum-jacketed insulated pipe according to the present invention.

FIG. 4 shows a simplified schematic drawing of a system to supply purified acetylene gas to an application according to embodiments of the invention;

FIG. 5 shows a simplified schematic drawing of a system to supply purified acetylene gas to an application according to additional embodiments of the invention; and

FIG. 6 shows a flowchart of selected steps in a method of purifying an acetylene process gas according to embodiments of the invention

### DETAILED DESCRIPTION OF THE INVENTION

Systems and methods are described for purifying acetylene gas by separating vapor and/or aerosol phase impurities as a liquid from the gas over a cooled purifying medium which may be positioned upstream or downstream from a filter membrane, such as but not limited to a coalescing filter, or a polymeric or ceramic membrane, and removing the liquid impurities from the purification equipment without interrupting the supply of the purified acetylene. These systems and methods may be used to purify acetylene sourced from high-pressure gas storage cylinders that contain a solvent medium such as acetone or dimethylformamide to dissolve and stabilize the stored acetylene. Solvent impurities that accompany the acetylene into the purification container may be separated from gaseous acetylene into a liquid phase in the cold purification container. The purification container is configured with a flow-controlled opening that allows the liquid phase impurities to drain from the container without interrupting the acetylene flow through the container.

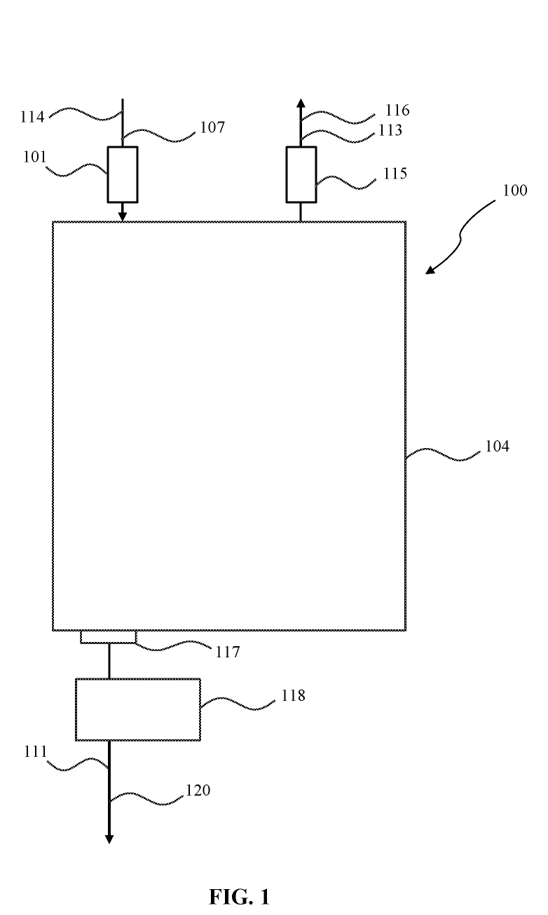

FIG. 1 shows a simplified schematic of an acetylene purifier system 100 according to embodiments of the invention. The purifier system 100 includes a purification container 104 that is operable to be cooled to a temperature below room temperature (e.g., from about 0° C to about -200° C). The purification container 104 may hold a high-surface area purifier material (not shown) in addition to a filter membrane, such as but not limited to a coalescing filter, or a polymeric or ceramic membrane (not shown) that is also cooled to the temperature of the container 104. The acetylene will permeate through the membrane and methane and other light hydrocarbons will be left behind on the residue/retentate side of the membrane. The efficiency of the acetylene purification and acetylene recovery will depend on the acetylene/methane separation factor for the membrane material, partial pressure difference of acetylene (driving force) across the membrane and effective surface area of membrane. Acetylene is more condensable and interactive molecule than other light hydrocarbons, such as methane and, therefore, has higher solubility and permeability through non-porous polymer materials. There will be some acetylene in the retentate stream which will be important in calculating recovery of acetylene. The membrane material for this separation could be a thin non-porous polymer membrane supported on a porous matrix. The membrane module configurations could be either spiral wound or hollow fiber. In addition, the purifier material exposed to the source acetylene provides surfaces for separating the liquid impurities (e.g., solvent impurities and light hydrocarbons) from the acetylene gas, while the coalescing filter works by forcing small liquid droplets (such as water, or solvents) to merge (coalesce) into larger droplets, which can then also be drained away by gravity. Sensors 107, 111 and 113 can be effectively used both upstream and downstream, respectively of purification container 104 to monitor and confirm the presence of moisture and removal of solvent from the source acetylene gas stream.

Source acetylene containing solvent impurities may be introduced to the purification container 104 through fluid inlet 114 that can be reversibly coupled to the acetylene source (not shown). In the present purification system, upstream sensor 107 is placed before the purification container 104 to measure the initial acetone concentration, as well as impurities such as solvent and moisture concentrations in the acetylene source stream, while downstream sensors 111 and 113 verify whether the removal process is effective. A control system (not shown) can then trigger alerts if either moisture or solvent levels remain high, ensuring process efficiency and product quality. Integrating these sensors (107, 111, and 113) enhances safety by preventing excessive moisture and/or solvent from reaching sensitive equipment and optimizes purification by allowing real-time adjustments. Overall, using sensor technology in acetylene purification provides continuous monitoring, process control, and improved safety, ensuring that the gas meets required purity standards. The following types of sensors are contemplated for use in the present invention: piezoelectric sensors detecting pressure changes in gases and liquids; capacitance sensors; thermal conductivity sensors; sound and sound resonance sensors; and infrared (IR) absorption sensors that detect solvent by measuring absorption in the IR spectrum, providing accurate, non-contact monitoring. Photoionization detectors (PID) may also be used to detect volatile organic compounds (VOCs) such as acetone Gas chromatography (GC) with a flame ionization detector (FID) may be used for quantification. Additionally, semiconductor-based VOC sensors, which operate by detecting conductivity changes in metal-oxide materials, may be used. The source acetylene gas stream flows through purifier or gas scrubber 101 before entering purification container 104 where it then decreases in temperature and continues to do so while flowing through the purification container 104, causing the solvent impurities to separate out as liquid impurities from the acetylene as the acetylene remains in the gas phase.

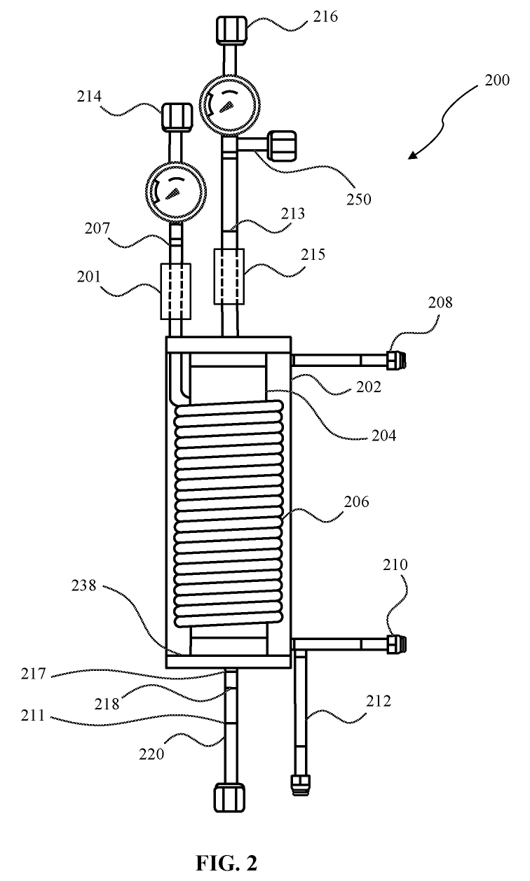

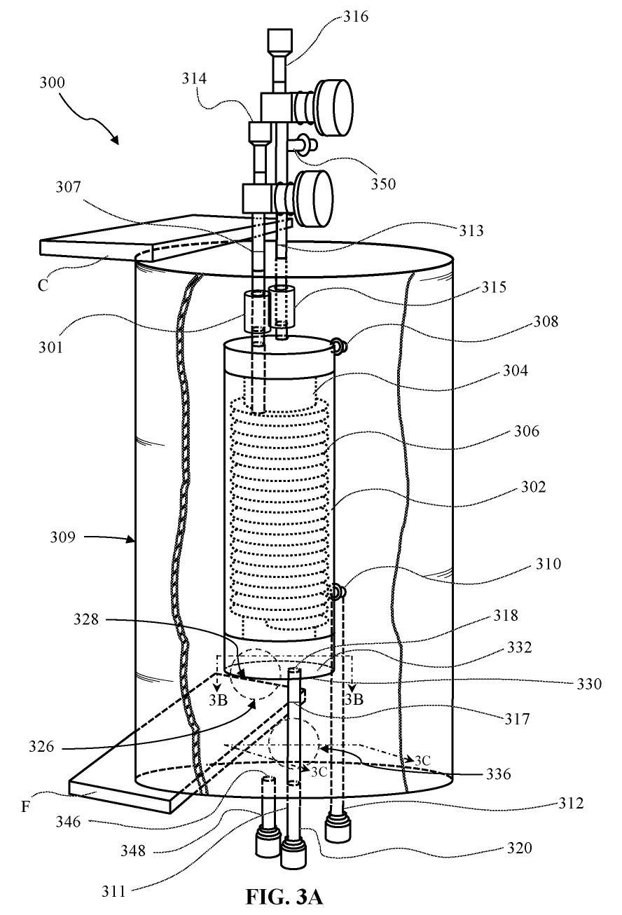

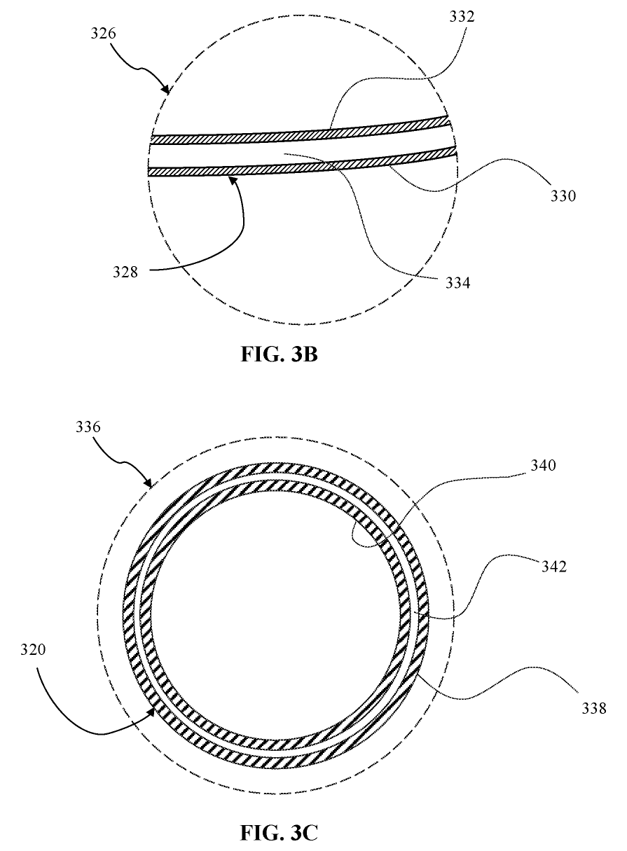

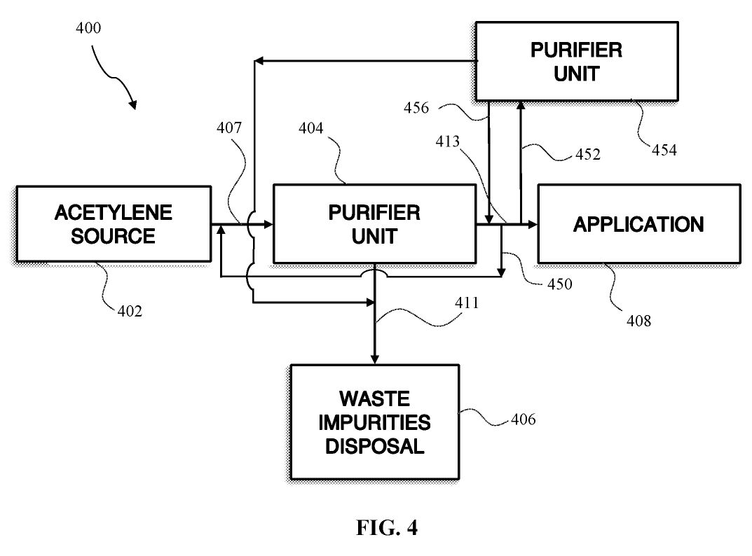

FIG. 2 shows an example of an acetylene purifier 200 according to additional embodiments of the invention. FIG. 3A provides a three-dimensional view of the purifier 200 further contained within. The purifier 200 in FIG. 2 includes an outer cooling container 202 that holds internal container 204 around which gas flow tube 206 is coiled. The cooling container 202 has a coolant inlet 210 and outlet 208 through which a coolant can circulate to maintain the gas flow tube 206 and internal purification container 204 at a temperature below ambient. The coolant inlet 210 and outlet 208 may be reversibly coupled to a circulating source of coolant fluid (not shown). The coolant outlet 208 may also be coupled to an auxiliary outlet 212 for draining residual coolant from the cooling container 202, among other functions.

Source acetylene may be introduced into the gas flow tube 206 through gas inlet 214 that can be reversibly coupled to an acetylene source (not shown). Prior to the introduction of the source acetylene into gas flow tube 206, the source acetylene passes by upstream sensor 107 designed to detect moisture and other impurities. As the gas moves across the sensor’s detection surface (not shown), any water vapor, particulate matter, or chemical contaminants present interact with the sensor’s sensing elements. These interactions generate measurable signals, such as changes in electrical resistance, capacitance, or optical properties, allowing the system to accurately assess gas purity in real-time. This data is stored in a control system (not shown) to later compare data from downstream sensor 211 which monitors impurities present in the waste stream and sensor 113 which measures the purified acetylene gas. The continuous monitoring ensures that even minute variations in moisture and impurity levels are detected, enabling precise quality control and system optimization. The source acetylene gas is then directed through a pre-filter 201 prior to flowing into the coiled gas flow tube 206. Pre-filter 201 may be a gas scrubber filled with dilute sulfuric acid (in the range of 5–10%) or dilute HCl (in the range of 5–10%) which can be used to neutralize alkaline impurities such as ammonia (NH₃) that may exist in a source acetylene, while a downstream purifier can be used to dry the purified acetylene.

The source acetylene cools while flowing through the coiled gas flow tube 206 and the solvent impurities can start to separate by gravity from the acetylene gas into a liquid phase. The separation of impurities into a liquid phase may continue as the acetylene flows from the gas flow tube 206 into the internal purification container 204 due to the presence of the cooled purifying medium as well a cooled filter membrane, such as but not limited to a coalescing filter, or a polymeric or ceramic membranes. The liquid impurity collects in the purification container 204, and the purified acetylene gas flows through drying filter 215, past sensor 213, and to gas outlet 216. As discussed previously, sensors 207, 211 and 213 all feed into a control system (not shown) that compares the various levels of impurities and can then trigger alerts if either moisture or solvent levels remain high, ensuring process efficiency and product quality. It is also possible depending on the level of purity detected at sensor 213 to redirect the purified gas through outlet 250 to an additional purification unit or back through purification unit 204 before being directed to the application. Alternatively, the purified gas could also be redirected to the waste stream. The gas outlet 216 may be reversibly coupled to an application (not shown) that uses the purified acetylene gas. In an alternate embodiment, the liquid and gas phases of the cooled acetylene gas may be further separated by the use of centrifugation or inertial impaction.

Examples of the heat sink device 217 may include without limitation, phase change material (PCM) heat sinks absorb and release heat gradually, making them ideal for temperature-sensitive equipment; thermal mass heat sinks, made from dense materials like copper or aluminum, store warmth and slowly distribute it; heat pipe heat sinks efficiently transfer heat to colder areas using a liquid-to-vapor phase change, while radiative heat sinks emit infrared radiation to warm nearby components; and liquid-cooled or heated cold plates circulate warm fluids for precise temperature control, and graphite heat spreaders evenly distribute heat across surfaces.

Examples of the flow control device 218 may include without limitation, an orifice, a needle valve, a mass flow controller, a check valve, a regulator, and a ball valve, among other devices. When the flow control device 218 is an orifice, the orifice may have a variety of shapes and sizes. For example, the orifice may be circular, elliptical, polygonal, etc. The flow control device 218 may be configured to prevent liquid impurities from accumulating in the purification container 204 at peak rates of separation of the impurities (usually at or near the endpoint of emptying an acetylene gas cylinder). Thus, the flow control device 218 is configured to accommodate a varying removal rate of the impurities and keep the removal rate above an accumulation threshold where the liquid impurities form so rapidly that they begin to collect upstream of the flow control device 218 in the purification container 204. The flow control device 218 may also be configured to reduce the amount of acetylene that is diverted from the application by instead passing through the conduit 220 with the liquid impurity. Embodiments size the orifice to have a cross-sectional area in the bottom surface of container 204, or downstream of the container 204, of about 8×10⁻⁹ cm² to about 1 cm². For example, a circular shaped orifice may have a diameter of about 1 μm to about 1 cm (e.g., about 1 μm to about 1 cm, about 10 μm to about 100 μm, about 50 μm, etc.).

The flow control device 218 may be set to keep the liquid impurities flowing continuously into the waste stream while the purified acetylene is being delivered to the application. Alternatively, the flow control device 218 may permit periodic release of the liquid impurities into the waste any time before they accumulate in the purification container 204 to a point where impurity levels start to increase in the purified acetylene exiting through gas outlet 216. In both cases, the removal of the impurities during the operation of the purifier can substantially reduce or eliminate the amount of down time required for draining, cleaning, and recharging the purification container 204.

Reducing or eliminating the accumulation of the liquid impurities and ice formation in the purification container 204 permits the purifier to provide a purified acetylene gas with low levels of solvent impurities over the life of an acetylene storage cylinder. Even as the percentage of solvent impurities in the source acetylene increases over the life of the cylinder (e.g., from starting with about 0.05 to 0.5 vol. % of the solvent impurity and finishing with about 5 to 10 vol. % or more), the purified acetylene is maintained with a relatively constant low level of these impurities (e.g., about 5 vol. % or less, about 1 vol. % or less, about 4000 ppm to about 10 ppm, by vol., etc., of solvent impurity in the purified acetylene).

FIG. 3A provides a three-dimensional view of the purifier 200 discussed above and shown in FIG. 2 further contained within housing 309 which is then positioned within a cabinet (not shown) having a floor F and ceiling C. The purifier 300 in FIG. 3A includes an outer cooling container 302 that holds internal container 304 around which gas flow tube 306 is coiled. The cooling container 302 has a coolant inlet 310 and outlet 308 through which a coolant can circulate to maintain the gas flow tube 306 and internal purification container 304 at a temperature below ambient. The coolant inlet 310 and outlet 308 may be reversibly coupled to a circulating source of coolant fluid (not shown). The coolant outlet 308 may also be coupled to an auxiliary outlet 312 for draining residual coolant from the cooling container 302, among other functions.

Source acetylene may be introduced into the gas flow tube 306 through gas inlet 314 that can be reversibly coupled to an acetylene source (not shown). Prior to the introduction of the source acetylene into gas flow tube 306, the source acetylene passes by upstream sensor 307 designed to detect moisture and other impurities. The resulting data is stored in a control system (not shown) to later compare data from downstream sensors 311 and 313 which monitor the impurities present in the waste stream and the purified acetylene gas, respectively. The source acetylene gas is then directed through a pre-filter 301 prior to flowing into the coiled gas flow tube 306. Pre-filter 301 may be a gas scrubber filled with dilute sulfuric acid (in the range of 5–10%) or dilute HCl (in the range of 5–10%) which can be used to neutralize alkaline impurities such as ammonia (NH₃) that may exist in a source acetylene, while a downstream purifier can be used to dry the purified acetylene.

The source acetylene cools while flowing through the coiled gas flow tube 306 and the solvent impurities can start to separate by gravity from the acetylene gas into a liquid phase. The separation of impurities into a liquid phase may continue as the acetylene flows from the gas flow tube 306 into the internal purification container 304 due to the presence of the cooled purifying medium and the liquid impurity collects in the purification container 304, and the purified acetylene gas flows, past sensor 313 and through drying filter 315 to gas outlet 316. The gas outlet 216 may be reversibly coupled to an application (not shown) that uses the purified acetylene gas. In an alternate embodiment, the liquid and gas phases of the cooled acetylene gas may be further separated by the use of centrifugation or inertial impaction.

The liquid impurities collecting in the purification container 304 migrate to the bottom of the container. A flow control device 318 may be formed in the purification container 304, or downstream of the container, to remove the impurities from the purification container 304. The flow control device 318 may be coupled to a conduit 320 that defines a vent channel for facilitating the exit of the liquid impurity from the purification container 304. The conduit 320 may be coupled to a vacuum source (not shown) that maintains a lower pressure on the conduit side of the flow control device 318 than the purification container 304 side. This establishes a decreasing pressure gradient that helps pull fluid impurities from inside the purification container 304 to the vent channel in conduit 320 and will operate as discussed in detail previously.

As discussed previously, due to the operating temperatures of purification container 304 there is a tendency for ice to form thereby blocking the flow of impurities through flow control device 318. To address the possibility of ice buildup a heat sink device 317 is positioned on the floor 328 of outer cooling container 302 to passively absorb and dissipate excess heat from the chiller component of the system. As discussed in further details below, the walls, top, and bottom of cooling container 302 may be vacuum insulated to aid in keeping the outside container temperature above ambient temperature thereby eliminating the formation of ice. FIG. 3B shows a magnified cross-sectional view 326 of the bottom 328 of outer cooling container 302 being formed with an inner wall 332 and an outer wall 330 forming an interstitial space 334 that may be vacuum sealed. Cooling container 302 is thus capable of keeping the inside environment at temperatures well below freezing while also keeping the outside temperature at ambient. This reduces the formation of moisture and water dripping into the cabinet holding the purification container 304. Due to the temperatures within purification container 304, it is also contemplated to provide conduit 320 with a vacuum jacket, see FIG. 3C which shows a magnified cross section view 336 of conduit 320 comprising an inner wall 340 and an outer wall 338 forming an interstitial space 342 that may be vacuum sealed. Conduit 320 is thus less vulnerable to freezing and may still be equipped with sensor 317.

The entire acetylene purifier 302 may further be positioned within a jacketed container 309 to further collect any moisture that forms on the outside of the acetylene purifier 302, the waste of which will enter orifice 346 and drained through conduit 348.

Referring now to FIG. 4, a simplified schematic drawing of a system 400 to supply purified acetylene gas to an application according to embodiments of the invention is shown. The system 400 includes an acetylene source 402, such as a high-pressure acetylene cylinder, that contains an unpurified mixture of acetylene and solvent impurity. The source acetylene is passed over sensor 407 which detects impurity levels and then sent to purifier unit 404 which includes a low-temperature purifier unit similar to the purifier described in FIGS. 1-3 above. As the source acetylene cools while moving through the purifier, the solvent impurity separates from the acetylene into a liquid phase. The liquid impurities are removed from the purifier unit 404 by passing through a flow control device, where the impurities are again measured by sensor 411 as they are directed to a waste disposal unit 406. The flow control device may be coupled to a conduit that opens into a vent channel in waste disposal unit 406 that is maintained at a reduced pressure, resulting in the re-evaporation of the liquid impurities.

As the liquid impurities travel from the purifier unit 404 to the waste disposal unit 406, a flow of purified acetylene with a significantly reduced concentration of the impurities passes through a drying filter, over an additional sensor 413 to an application 408. Sensors 407, 411 and 413 all feed into a control system (not shown) that compares the various levels of impurities and can then trigger alerts if either moisture or solvent levels remain high, ensuring process efficiency and product quality. Integrating these sensors 407, 411, and 413 enhances safety by preventing excessive moisture and/or solvent from reaching sensitive equipment and optimizes purification by allowing real-time adjustments. Depending on the level of purity detected at sensor 413 the purified acetylene gas may be directed via conduits 450 and 456 through an additional step of purification or alternatively through conduits 452 to an additional purification unit 454 prior to reaching application 408. The application 408 that consumes the purified acetylene may include a semiconductor fabrication process application such as making an ashable hard mask for patterning an integrated circuit.

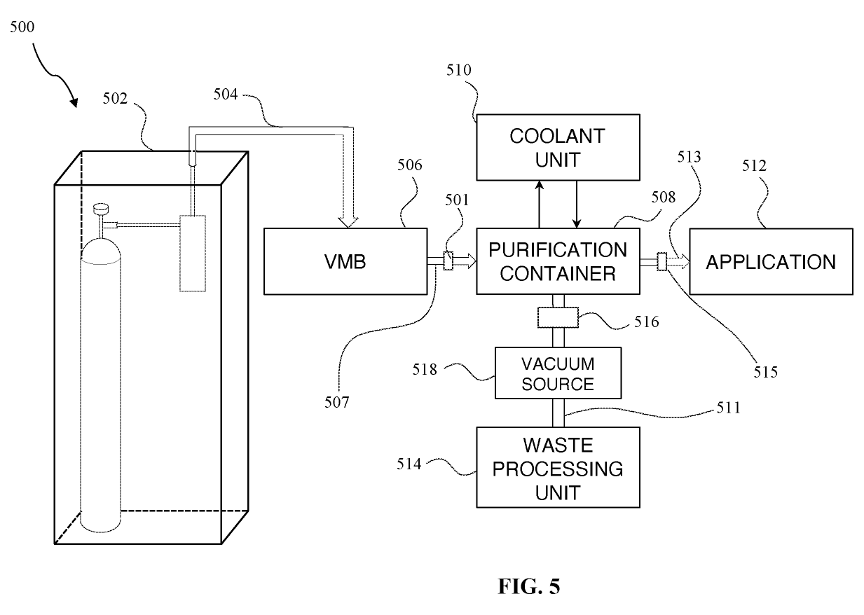

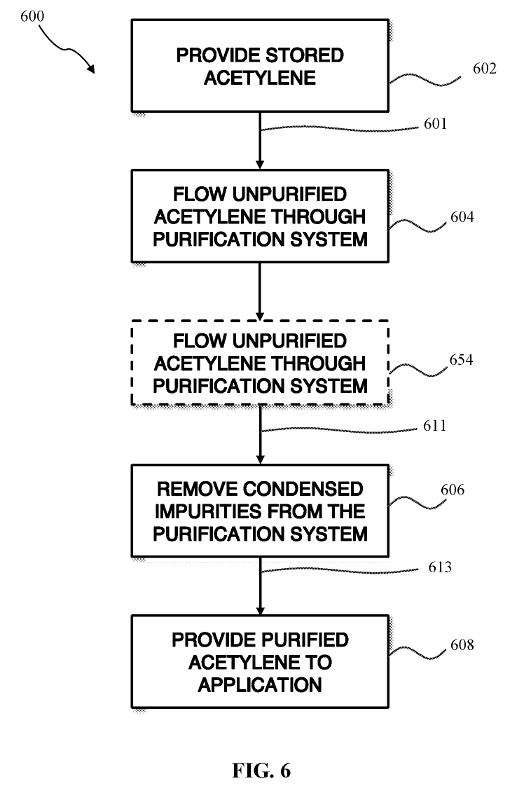

FIG. 5 shows a simplified schematic drawing of a system 500 to supply purified acetylene gas to an application according to embodiments of the invention. System 500 shows a stored acetylene source 502 in the form of a high-pressure acetylene gas cylinder. The acetylene is stored in the cylinder with a solvent, such as acetone or dimethylformamide which dissolves and helps maintain the stability of the acetylene during the storage period. In the embodiment shown, the acetylene gas cylinder is housed in a cabinet which may include ventilation conduits, gas sensors, and controllers that permit a system operator to control system operations such as gas shut off, flow rates, etc.

The source acetylene gas exits the acetylene source through supply conduit 504 for purification in the low-temperature purification unit 508. In system 500, the flow rate and pressure of source acetylene reaching the purification unit 508 is controlled by a valve manifold box (VMB) 506. In the embodiment shown, the VMB 506 is separate from both the acetylene source 502 and the purification unit 508. In additional embodiments, VMB 506 may be integrated into the acetylene source 502 (e.g., integrated into the gas cabinet) or the purification unit 508 (e.g., directly coupled to an inlet gas flow tube of the purifier).

The source acetylene flows through an initial purification step 501 prior flowing over sensor 507 and then moving through the cooled purification unit 508 whereupon a portion of the solvent impurity separates from the acetylene into a liquid phase. Coolant fluid is cycled through the purification unit 508 by a separate coolant unit 510 fluidly coupled to the purification unit. In additional embodiments (not shown) a coolant unit may be integrated with the purification unit. The cooled purification unit 508 may be constructed with vacuum sealed walls to minimize thermal transfer thereby allowing the temperature of the outer surface to be greater than the inner surface. Consequently, condensation, ice formation, and water dripping are minimized; however, it is further contemplated to support cooled purification unit 508 within housing so that any moisture produced can easily be contained and removed.

The purification unit 508 separates the source acetylene into a purified gas which flows through a purifier 515 to ensure drying prior and past sensor 513 prior to being sent to the application 512 and the liquid impurities (primarily solvent impurities) travel past sensor 511 as they are sent to a waste processing unit 514. As discussed previously, sensors 507, 511 and 513 all feed into a control system (not shown) that compares the various levels of impurities and can then trigger alerts if either moisture or solvent levels remain high, ensuring process efficiency and product quality. It is also possible depending on the level of purity detected at sensor 513 to redirect the purified gas to an additional purification unit, back through purification unit 508 or to the waste stream. As noted above, the liquid impurities may pass through a flow control device 516 in a container that collects liquid impurities from the chilled acetylene gas stream over the purifying medium. The flow control device 516 may be formed in the container near a heat sink device or downstream of the container where the force of gravity and/or pressure gradient draws the liquid impurities. In the embodiment shown, a flow control device 516 controls the rate of impurity removal from the container. Examples of flow control device 516 may include an orifice, mass flow controller, needle valve, and/or other device to control the flow rate of impurities exiting the purification unit 508. A vacuum source 518 may also be coupled to the flow control device 516 to create decreasing pressure gradient that accelerates the flow of liquids exiting the purification unit 508 through the flow control device 516. The vacuum source 518 may also create a low-pressure region downstream of the flow control device 516 that re-vaporizes the liquid impurities allowing their transportation from system 500 in the gas phase.

FIG. 6 shows selected steps in a method 600 of purifying an acetylene process gas according to embodiments of the invention. The method 600 includes the step of providing a stored acetylene source 602. The provided acetylene source may be a high-pressure acetylene gas cylinder that also includes a solvent that dissolves and helps to stabilize the acetylene during storage. The source acetylene released from the acetylene source is allowed to pass by sensor 601 prior to flowing through a purification system 604. The gas flow rate and pressure of these releases may be regulated by, for example, pressure regulators, mass flow controllers, and/or needle valves, among other equipment, to maintain a substantially constant gas pressure in the purification system.

The purification system itself may be constructed using an insulated housing which may include a low-temperature purifier that separates solvent impurities into a liquid phase that is separated from the acetylene remaining in the gas phase. The liquid phase impurities pass over sensor 611 where they can be measured prior to removal from the purification system 606, while the purified acetylene produced by the system is exposed to sensor 613 and, depending on the purification level, is either provided to the end use application 608 or passed through purification system 606 again before being provided to the end use application 608. The concurrent removal of liquid impurities and supply of purified acetylene may be accomplished by providing a heat sink device in close proximity to an outlet (e.g., a flow control device) in a purification container or downstream of the container that allows the liquid impurities to remain at a temperature above their freezing point and to drain from the container as acetylene gas flows through the container. The container is maintained at a constant low temperature (e.g., about 0° C to about −200° C, about −20° C to about −50° C, about −45° C, etc.) through contact with a coolant fluid at an external surface of the container. The coolant fluid may be circulated around the container carrying away heat energy from the container to maintain a substantially constant low temperature inside the container. Due to the insulated construction of the container, the outside temperature of purification system 604 is maintained at a temperature which is closer to ambient even though the inside is substantially colder.

By maintaining the acetylene gas at a constant pressure and temperature in the purification container of the purification system, a purified acetylene gas can be supplied to the end use application with a constant and consistent low level of solvent impurities. For example, the purified acetylene gas may have a residual level of solvent impurities of about 5 vol. %, 4 vol. %, 3 vol. %, 2 vol. %, 1 vol. %, 0.5 vol. %, 4000 ppm, 3000 ppm, 2000 ppm, 1000 ppm, 500 ppm, 250 ppm, 100 ppm, 50 ppm, 25 ppm, 10 ppm, by vol., etc. Variation in the impurity concentration for the purified acetylene is reduced by removing liquid impurities from the purification unit during operation. This prevents the accumulation of liquid impurities to a level where the purifier becomes saturated and has difficulty separating additional solvent impurities from the acetylene gas stream.

In addition, the impurity removal process is designed to accommodate varying rates of liquid impurity production in the purification system. As noted above, the concentration of solvent impurity from an acetylene gas source can change significantly over the lifetime of the source. For acetylene stored in a high-pressure gas storage cylinder, the concentration of solvent impurities can increase from about 0.05 vol. % to about 10 vol. % or more at the end of the cylinder's supply. The impurity removal process can accommodate this many-fold increase in solvent impurity concentration by allowing the liquid solvent impurities to drain from the purification system at an increased rate over time to maintain a zero or low level of liquid accumulation in the purification container, and consequently a consistently low level of impurities in the purified acetylene.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

Reference throughout this specification to "one embodiment," "certain embodiments," "one or more embodiments" or "an embodiment" means that a particular feature, structure, material, or characteristic described in connection with the embodiment is included in at least one embodiment of the invention. Thus, the appearances of the phrases such as "in one or more embodiments," "in certain embodiments," "in one embodiment" or "in an embodiment" in various places throughout this specification are not necessarily referring to the same embodiment of the invention. Furthermore, the particular features, structures, materials, or characteristics may be combined in any suitable manner in one or more embodiments.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, materials and methods according to some embodiments are described herein. While the invention has been described in detail herein in accord with certain preferred embodiments thereof, many modifications and changes therein may be effected by those skilled in the art. Without further elaboration it is believed that one skilled in the art can, using the description set forth above, utilize the invention to its fullest extent.

As used herein and in the appended claims, the singular forms “a”, “an”, and “the” include plural referents unless the context clearly dictates otherwise. Thus, for example, reference to “a process” includes a plurality of such processes and reference to “the impurity” includes reference to one or more impurities and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A system for purifying an acetylene process gas, the system comprising:
an acetylene vessel comprising source acetylene mixed with a solvent impurity;
a purification container fluidly coupled to the acetylene vessel, wherein said purification container contains a purifier medium upon which at least a portion of said solvent impurity in said source acetylene separates out as a condensed liquid impurity and at least a portion separates out as a purified acetylene gas;
a temperature control system thermally coupled to said purification container, where said temperature control system lowers a temperature of said purifier medium to promote the separation of said solvent impurity from said source acetylene gas on said purifier medium;
a heat sink device formed in said purification container, wherein said heat sink device regulates temperature gradients and prevents ice formation by dissipating excess heat from said temperature control system thereby absorbing excess cold energy near moisture-prone areas;
a flow control device formed in said purification container or coupled to said purification container, wherein said flow control device allows passage of said condensed liquid impurity out of said purification container while said source acetylene flows into said purification container, and wherein a first outlet formed in said purification container is coupled to a vent channel located outside the purification container, the vent channel facilitating flow of said condensed liquid impurity out of said purification container;
a second outlet formed in said purification container through which said purified acetylene gas passes, wherein said purified acetylene gas has a concentration of the solvent impurity of about 5 vol.% or less, and wherein said condensed liquid impurity is removed while said purified acetylene gas flows from said purification container to keep the concentration of said solvent impurity substantially constant in the purified acetylene gas; and
at least three sensors, comprising a first sensor positioned at the entry point of said purification container where said source acetylene gas enters, a second sensor positioned in said vent channel, where said condensed liquid impurities exit said purification chamber, and a third sensor positioned at the exit point of said purification container wherein said purified acetylene gas exits.

2. The system of claim 1, further comprising a control system operably connected to said at least three sensors which monitors and compares the total impurity levels detected at each sensor and is capable of triggering alerts if either moisture or solvent levels remain high, ensuring process efficiency and product quality.

3. The system of claim 1, further comprising a vent channel connected to said second outlet in said purification container through which purified acetylene gas flows, wherein, depending upon the purity level detected by said third sensor, said purified acetylene gas is directed either to an application, back through an additional purification step, or to the waste stream.

4. The system of claim 3, where said additional purification step either directs said purified gas back through said purification container or through a second purification container.

5. The system of claim 1, wherein a first purifier is positioned between said first sensor and said purification container and a second purifier is positioned between said third sensor and said purification container.

6. The system of claim 5, wherein said first filter purifier comprises a gas scrubber filled with dilute sulfuric acid in the range of 5–10% or dilute HCl in the range of 5–10% which can be used to neutralize alkaline impurities such as ammonia, while said second purifier is used to dry said purified acetylene gas.

7. The system of claim 1, wherein said heat sink device is selected from the group consisting of phase change material, thermal mass heat sinks, heat pipe heat sinks, liquid-cooled or heated cold plates, and graphite heat spreaders.

8. The system of claim 1, wherein said purification chamber is formed using vacuum jacketed walls.

9. The system of claim 1, wherein said vent channel that receives said condensed liquid impurities is vacuum jacketed to prevent ice formation.

10. The system of claim 1, wherein said vent channel that receives said condensed liquid impurities contains a vortex tube positioned at said first outlet of said purification chamber.

11. The system of claim 1, wherein the concentration of said liquid solvent impurity in said purified acetylene gas is about 1 vol. % or less.

12. The system of claim 1, wherein said flow control device is coupled to said acetylene vessel and said purification chamber to allow regulation of a flow rate of said source acetylene gas into said purification chamber.

13. The system of claim 1, wherein said vent channel has a lower internal pressure than said purification chamber to create a decreasing pressure gradient from said purification container to said vent channel.

14. The system of claim 1, wherein the system maintains said source acetylene gas at a constant temperature and pressure in said purification container.

15. The system of claim 1, wherein said separated condensed liquid impurity is re-vaporized in the vent channel before being exhausted from the system.

16. The system of claim 1, wherein said condensed liquid impurity is dispensed in said liquid phase.

17. The system of claim 1, wherein said flow control device is selected from the group consisting of an orifice, a needle valve, a mass flow controller, a check valve, a regulator, and a ball valve to prevent said separated condensed liquid impurity from accumulating in said purification container.

18. The system of claim 1, wherein the acetylene vessel comprises a high-pressure gas storage cylinder.

19. The system of claim 1, wherein said solvent impurity mixed with the source acetylene in said acetylene vessel comprises acetone or dimethylformamide.

20. The system of claim 1, wherein said condensed liquid impurity is intermittently removed from the purification container.

21. A system for purifying an acetylene process gas, the system comprising:
an acetylene vessel comprising source acetylene mixed with a solvent impurity;
a membrane material for separating acetylene from light hydrocarbons;
a purification container fluidly coupled to the acetylene vessel, wherein said purification container contains a purifier medium upon which at least a portion of said solvent impurity in said source acetylene separates out as a condensed liquid impurity and at least a portion separates out as a purified acetylene gas;
a temperature control system thermally coupled to said purification container, where said temperature control system lowers a temperature of said purifier medium to promote the separation of said solvent impurity from said source acetylene gas on said purifier medium;
a heat sink device formed in said purification container, wherein said heat sink device regulates temperature gradients and prevents ice formation by dissipating excess heat from said temperature control system thereby absorbing excess cold energy near moisture-prone areas;
a flow control device formed in said purification container or coupled to said purification container, wherein said flow control device allows the passage of said condensed liquid impurity out of said purification container while said source acetylene flows into said purification container, wherein a first outlet formed in said purification container is coupled to a vent channel outside the purification container, wherein said vent channel facilitates said condensed liquid impurity flowing out of said purification container;
a second outlet formed in said purification container through which said purified acetylene gas passes, wherein said purified acetylene gas has a concentration of the solvent impurity of about 5 vol.% or less, and wherein said condensed liquid impurity is removed while said purified acetylene gas flows from said purification container to keep the concentration of said solvent impurity substantially constant in the purified acetylene gas; and
at least three sensors, comprising a first sensor positioned at the entry point of said purification container where said source acetylene gas enters, a second sensor positioned in said vent channel, where said condensed liquid impurities exit said purification chamber, and a third sensor positioned at the exit point of said purification container wherein said purified acetylene gas exits.

22. The system of claim 21, wherein said membrane material is further positioned within said purification container.

23. The system of claim 21, wherein said membrane material is a thin non-porous polymer membrane supported on a porous matrix.

24. The system of claim 22, wherein said membrane material is configured as a spiral wound or hollow fiber.

25. A system for purifying an acetylene process gas, the system comprising:
an acetylene vessel comprising source acetylene mixed with a solvent impurity;
a purification container fluidly coupled to the acetylene vessel, wherein said purification container contains a purifier medium upon which at least a portion of said solvent impurity in said source acetylene separates out as a condensed liquid impurity and at least a portion separates out as a purified acetylene gas;
a temperature control system thermally coupled to said purification container, where said temperature control system lowers a temperature of said purifier medium to promote the separation of said solvent impurity from said source acetylene gas on said purifier medium;
a heat sink device formed in said purification container, wherein said heat sink device regulates temperature gradients and prevents ice formation by dissipating excess heat from said temperature control system thereby absorbing excess cold energy near moisture-prone areas;
a flow control device formed in said purification container or coupled to said purification container, wherein said flow control device allows the passage of said condensed liquid impurity out of said purification container while said source acetylene flows into said purification container, wherein a first outlet formed in said purification container is coupled to a vent channel outside the purification container that facilitates said condensed liquid impurity flowing out of said purification container; and
a second outlet formed in said purification container through which said purified acetylene gas passes, wherein said purified acetylene gas has a concentration of the solvent impurity of about 5 vol.% or less, and wherein said condensed liquid impurity is removed while said purified acetylene gas flows from said purification container to keep the concentration of said solvent impurity substantially constant in the purified acetylene gas.

26. The system of claim 25, wherein said system further comprises at least three sensors, the first of which is positioned at the entry point of said purification container where said source acetylene gas enters, the second of which is positioned in said vent channel where said condensed liquid impurities exit said purification chamber, and the third of which is positioned at the exit point of said purification container where said purified acetylene gas exits.

27. The system of claim 25, wherein said system further comprising a membrane material for separating acetylene from light hydrocarbons.

28. The system of claim 27, wherein said membrane material is further positioned within said purification container.

29. The system of claim 28, wherein said membrane material is a thin non-porous polymer membrane supported on a porous matrix.

30. The system of claim 29, wherein said membrane material is configured as a spiral wound or hollow fiber.

31. A system for purifying an acetylene process gas, the system comprising:
an acetylene vessel comprising source acetylene mixed with a solvent impurity;
a purification container fluidly coupled to the acetylene vessel, wherein said purification container contains a purifier medium upon which at least a portion of said solvent impurity in said source acetylene separates out as a condensed liquid impurity and at least a portion separates out as a purified acetylene gas;
a temperature control system thermally coupled to said purification container, where said temperature control system lowers a temperature of said purifier medium to promote the separation of said solvent impurity from said source acetylene gas on said purifier medium;
a flow control device formed in said purification container or coupled to said purification container, wherein said flow control device allows the passage of said condensed liquid impurity out of said purification container while said source acetylene flows into said purification container, wherein a first outlet formed in said purification container is coupled to a vent channel outside the purification container that facilitates said condensed liquid impurity flowing out of said purification container;
a second outlet formed in said purification container through which said purified acetylene gas passes, wherein said purified acetylene gas has a concentration of the solvent impurity of about 5 vol.% or less, and wherein said condensed liquid impurity is removed while said purified acetylene gas flows from said purification container to keep the concentration of said solvent impurity substantially constant in the purified acetylene gas; and
at least three sensors, the first of which is positioned at the entry point of said purification container where said source acetylene gas enters, the second of which is positioned in said vent channel, where said condensed liquid impurities exit said purification chamber, and the third of which is positioned at the exit point of said purification container wherein said purified acetylene gas exits.

32. The system of claim 31, wherein said system further comprising a heat sink device formed in said purification container, wherein said heat sink device regulates temperature gradients and prevents ice formation by dissipating excess heat from said temperature control system thereby absorbing excess cold energy near moisture-prone areas.

33. The system of claim 30, wherein said system further comprising a vaporizer positioned up steam of said flow control device to vaporize all fluids before draining through said flow control device.

34. The system of claim 30, wherein said vent channel is under vacuum.
